(19) United States
(12) Patent Application Publication
(10) Pub. No.: US 2008/0183632 A1
(43) Pub. Date: Jul. 31, 2008

(54) Business method for brand creation and marketing

(75) Inventors: Marina Gazetova, Visaginas (LT); Rafael Gazetov, Visaginas (LT)

Correspondence Address: YOUNG & THOMPSON, 209 Madison Street, Suite 500, ALEXANDRIA, VA, 22314, US

(73) Assignee: UAB "IEEC", VILNIUS (LT)

(21) Appl. No.: 11/700,011

(22) Filed: Jan. 31, 2007

(51) Int. Cl. H04L 9/00

(52) U.S. Cl. 705/80

(57) ABSTRACT

A business method for brand creation and marketing is performing by multiple sales of personal or legal entity attributes, for example names, surnames, own corporate parent brands, logotypes, popularity, reputation, trust, prestige and other attributes between sellers and purchasers, namely: from persons to persons; from legal entities to persons; from persons to legal entities, from legal entities to legal entities with simultaneous creation of multiple independent compound personal or legal entity attributes, for example independent compound brands between them. In the process of these multiple sales personal or legal entity attributes with creation of multiple compound personal or legal entity attributes or independent compound brands between them simultaneously, contains permanent and variable parts, which are united by single visual or sound solution as recognisable symbol of definite shape, colour or sound, purchasers become independent compound personal attribute owners, independent compound legal entities attribute owners or independent compound brand owners.

### FIELD OF THE INVENTION

The present invention relates to Internet based brand marketing business methods. The present invention reveals trends relevant to new brand opportunities for persons or legal entities. The present invention can be widely used in different fields and human activities spheres, in all community groups, for example business, science, sport, art, culture, music and other spheres, where creation and selling of independent compound brands can take place from persons to persons, from legal entities to persons, from persons to legal entities, from legal entities to legal entities. The creation process of independent compound personal attributes, independent compound legal entity attributes or independent compound brands can be carried out as traditionally as through the multi level marketing networks. For example, creation and selling of independent compound personal attributes, independent compound legal entity attributes or independent compound brands can be carried out from direct selling companies to their independent salespersons.

### BACKGROUND

In the traditional brand selling, where sellers are owners of personal attributes, legal entity attributes or classic brands, sell them to purchasers for fixed price and under the definite rights, and as a result of such bargain, the owners of personal attributes, legal entity attributes or classic brands become purchasers and sellers lose ownership on personal attributes, legal entity attributes or classic brands.

Thus, traditional brand selling does not use competitive advantages and new opportunities, which open independent compound personal attributes, independent compound legal entity attributes or independent compound brands and does not use deep motivation of independent compound personal attribute owners, independent compound legal entity attribute owners or independent compound brand owners, what affect their strengthening of ability to sell.

### SUMMARY OF THE INVENTION

The present invention has been made to overcome the disadvantages as mentioned above, and therefore, has an object to provide brand creation and marketing business method that allows any persons or legal entities, companies and their customers to create new joint products and effective tools as independent compound personal attributes, independent compound legal entity attributes or independent compound brands. The present invention provides new opportunities for different groups of community, in public and business sector including direct selling sector and other fields and spheres.

The present invention provides new opportunities for all persons, especially for famous persons, who have definite level of popularity, trust, prestige and reputation in society. Famous persons sell their own brands multiply, their names, surnames, popularity, trust, prestige, reputation and other personal attributes to other less famous or not famous persons through the creation mechanism of independent compound personal attributes, independent compound legal entity attributes or independent compound brands. Sellers and purchasers get benefits and profits in this process.

The present invention provides to sellers, famous persons getting following benefits: essential raising of popularity, trust, prestige and reputation in society and long time retention of achieved high level of popularity, trust and reputation (extended life time).

In the present invention, for sellers, famous persons, profits are provided by cash flow for rights purchasing and annual support services cash flow during the whole extended life time of their popularity, trust, prestige and reputation in society, which arise after multiple selling of own brands, popularity, trust, prestige, reputation and other personal attributes to other less famous or not famous persons. Here with, the permanent profits are provided by creation of own business networks for example, multi level independent compound brand networks.

The present invention provides to purchasers, less famous or not famous in society persons following benefits: obtainment a definite level of popularity, trust, reputation and prestige, the sense of belonging to famous and known persons through the compound with them personal attributes, legal entity attributes or brands, and also new business and other opportunities.

The present invention provides new opportunities for all legal entities, for example for small medium enterprises or large companies, corporations, investment funds, banks and other, which has a branch of own business networks with numerous customers, and also numerous stockholders and partners. These legal entities sell their corporate parent brands, own names, popularity, trust, prestige, reputation and other legal entity attributes to numerous customers many times, and also to own numerous stockholders and partners through independent compound legal entity attributes or independent compound brands creation mechanism. Sellers and purchasers get own benefits and profits in this process.

The present invention provides to sellers, legal entities getting of following benefits: essential enlargement of own business networks and increasing of customers, essential raising of popularity, trust, prestige and reputation level and keeping of achieved high level of popularity, trust, prestige and reputation for a long time (extended life time).

In the present invention, profits for sellers, legal entities are provided by cash flow for rights purchasing and annual support services cash flow during the whole extended life time of their popularity, trust, prestige and reputation, which arrives after multiple selling of own parent brands, popularity, trust, prestige, reputation and other legal entity attributes to numerous customers, and also numerous stockholders and partners. Thereat, the growth of profits is provided by expanding of own business networks, for example, multi level independent compound brand networks.

The present invention provides the following benefits to purchasers, numerous customers, stockholders and partners: purchasing of definite level of popularity, trust, reputation and prestige, a sense of belonging to famous and known companies, corporations, investment funds, banks and other legal entities through the independent compound personal attributes, independent compound legal entity attributes or independent compound brands, and also a new business and other opportunities. The main idea of this global business method is that every purchaser has a sense of belonging to real elite through the independent compound personal attributes, independent compound legal entity attributes or independent compound brand, which is not accessible for everyone.

In the present invention independent compound personal attributes, independent compound legal entity attributes or independent compound brands obtain the property of duality, that is in one case it is a product, which has market perspective and market price, and in other case it is an effective management, advertisement, promotion, branding, successful strategies implementation and effective economy policy instrument which allows to independent compound brand owners to achieve mass selling, simultaneously keeping their individuality and ensure increasing of products and services of sellers, persons or legal entities selling, expansion of existing market segments, and penetration to other target markets.

The present invention provides to each independent compound personal attribute owner, independent compound legal entity attribute owner or independent compound brand owner a strong motivation, which affects his ability to sell, keeping an individuality each of them simultaneously.

Independent compound personal attribute owners, independent compound legal entity attribute owners or independent compound brand owners, armed with a new product and effective instrument as independent compound personal attributes, independent compound legal entity attributes or independent individual compound brands, have new business opportunities, new bright individuality and develop own business-groups under the flag of own personal or legal entities attributes or brands, using all their advantages. In other words, each independent compound personal attribute owner, independent compound legal entity attribute owner or independent compound brand owner purchasing the definite right to be identified with famous persons or legal entities with their parent brands, popularity, prestige, trust, reputation and other famous personal or legal entity attributes. Independent compound personal attribute owners, independent compound legal entity attribute owners or independent compound brand owners are ready to pay for desire to join the strongest of our world through the personal or legal entity attributes or compound brands. Thereat, independent compound personal attribute owners, independent compound legal entity attribute owners or independent compound brand owners accept responsibility to sellers, famous persons or famous legal entities.

The present invention provides creation of new information strategy of independent compound personal attributes, independent compound legal entity attributes or independent compound brands and provides a quite new approach in the branding sphere. Permanent generation of increasing quantity of independent compound personal attributes, independent compound legal entity attributes or independent compound brands does not mean that uncontrolled stream of new brands is disembogued to the market and their superfluity arises (over branding). It means that independent compound personal attribute owners, independent compound legal entity attribute owners or independent compound brand owners affect purchasers and customers on the subconscious and conscious levels many times as permanent influence and multiple, mass but controlled life advertisement, and independent compound personal attribute owners, independent compound legal entity attribute owners or independent compound brand owners are active carriers of this advertisement and also life brands, what push purchasers and customers to take decision to purchase. All processes, including generation and mass output of permanently increasing quantity of independent compound personal attributes, independent compound legal entity attributes or independent compound brands to the market processes are managed and coordinated effectively by on purposed developed software, in the framework of developed for each seller, person or legal entity, own strategy.

The present invention provides protection of own and parent brands, popularity, trust, prestige, reputation and other personal or legal entity attributes of sellers from any damage, and independent compound personal attributes, independent compound legal entity attributes or independent compound brands are intermediate protection barriers, which provide distance between personal or legal entity attributes of sellers and customers and independent compound personal attribute owners, independent compound legal entity attribute owners or individual compound brand owners accept all risks and responsibilities for any damage, however damage risks are reducing inversely to increasing quantity of independent compound personal attribute owners, independent compound legal entity attribute owners or independent compound brand owners, distributing among their megabuck audience.

In the present invention, sellers, persons or legal entities do not spend own assets and efforts to promote own parent brands, popularity, trust, prestige, reputation and other personal or legal entity attributes at the market. Conversely, purchasers and customers who become independent compound personal attribute owners; independent compound legal entity attribute owners or independent compound brand owners pay for new business opportunities which are arising for them. Thereat, independent compound personal attribute owners, independent compound legal entity attribute owners or independent compound brand owners will spend own forces, efforts and assets to promote own brands, products and services at the market.

In the present invention, each independent compound personal attribute owner, independent compound legal entity attribute owner or independent compound brand owner who purchases new purposes and directions of movement, and also additional motivation for more deep penetration to the target markets. Thereat, independent compound personal attribute owners, independent compound legal entity attribute owners or independent compound brand owners assume additional responsibility before of itself, purchasers and customers. Each potential purchaser and customer perceives independent compound personal attributes, independent compound legal entity attributes or independent compound brands and independent compound personal attribute owners, independent compound legal entity attribute owners or independent compound brand owners as unified whole.

In the present invention trading promotion is carried out simultaneously, directed to distributors, and buying promotion directed to customers. Average flexibility of promotion is higher than of advertisement from 8 to 20 times. The present invention provides integration of advertisement and promotion (Integrated Marketing Communications) and more full logically linked information. Such constitutional approach and correct using of promotion are raising attention of purchasers to purchasing of independent compound personal attributes, independent compound legal entity attributes or independent compound brands.

In the present invention power synergy of all megabuck audience of independent compound personal attributes, independent compound legal entity attributes or independent compound brands is provided, on conditions their full coordination between each other. Economic value of the present invention increasing exponential and equal to square of independent compound personal attribute owners, independent compound legal entity attribute owners or independent compound brand owners (C=N², Robert Metcalf Low). Permanently increasing family of independent compound personal attributes, independent compound legal entity attributes or independent compound brands have much bigger power, than separate brands of sellers, famous persons or legal entities because of measureless bigger accumulated power emotional intellect of all independent compound personal attribute owners, independent compound legal entity attribute owners or independent compound brand owners, enhanced of own brand possession sense and their literate management. Each independent compound personal attributes owner, independent compound legal entity attributes owner or independent compound brand owner feels possession to high elite, value and prestige of own brand and also linking to own emotions, penetrates such brand to the new areas of activity easier. This allows to each purchaser to create own business on the background of long-time strategic plans. Thereat high level of mutual trust between sellers and purchasers is ensured and also mutual addition and appropriateness to each other. Allegiance and loyalty of independent compound personal attribute owners, independent compound legal entity attribute owners or independent compound brand owners to sellers, famous persons or legal entities is increasing.

In the present invention, on purpose developed software provides creation and generation of permanently increasing quantity of independent compound personal attributes, independent compound legal entity attributes or independent compound brands family, implementing of independent compound personal attributes, independent compound legal entity attributes or independent compound brands web selling, accounting, reporting, management, preparing and publishing of certificates in fail and hard copies for independent compound personal attribute owners, independent compound legal entity attribute owners or independent compound brand owners and other required service connected with servicing permanently increasing quantity of independent compound personal attributes, independent compound legal entity attributes or independent compound brands including ability to image independent compound personal attribute owners, independent compound legal entity attribute owners or independent compound brand owners on the web sites. The creation of independent compound personal attributes, independent compound legal entity attributes or independent compound brands management single system via on purpose software will let coordinate actions of all independent compound personal attribute owners, independent compound legal entity attribute owners or independent compound brand owners in the same strategy, without limiting their freedom. Thereat, sellers, persons or legal entities will have additional abilities to impact on the process of increasing volumes of own product sales by independent compound personal attribute owners, independent compound legal entity attribute owners or independent compound brand owners.

In this unique business method independent compound personal attributes, independent compound legal entity attributes or independent compound brands are very important part of independent compound personal attribute owners, independent compound legal entity attribute owners or own independent compound brand owner assets which let them to achieve passive income faster.

The present invention lets to raise own self-concept of each independent compound personal attributes owner, independent compound legal entity attributes owner or independent compound brand owner essentially, gives them stronger self-reliance and develops their leadership practices. A known fact is that money goes not to that business where products or services are better, but when leaders and management group are better, strong group of independent compound personal attribute owners, independent compound legal entity attribute owners or independent compound brand owners. Purchasing of independent compound personal attributes, independent compound legal entity attributes or individual compound brands and annual services fee for long-term support of independent compound personal attributes, independent compound legal entity attributes or independent compound brands are reinvestment to own business of independent compound personal attribute owners, independent compound legal entity attribute owners or independent compound brand owners and to development and enlargement of own business groups.

In the present invention when a new independent compound personal attribute owner, independent compound legal entity attribute owner or independent compound brand owner, sellers, persons or legal entities obtain additional assets, which provide income for them in the future. With each new purchasing of such additional asset the balance cost of sellers' assets is growing up.

The present invention lets to each independent compound personal attribute owner, independent compound legal entity attribute owner or independent compound brand owner to be much closer to purchasers and customers. Nearness to purchasers and customers—it is business success criteria, especially in direct selling fields. In the same time, each independent compound personal attribute owner, independent compound legal entity attribute owner or independent compound brand owner feels responsibility and he is under the definite patronage of sellers, persons or legal entities. Thereat, longstanding and strong sellers relationship with each independent compound personal attribute owner, independent compound legal entity attribute owner or independent compound brand owner separately are establishing, what is very important to their compound business.

The present invention provides a creative approach for conception realisation of increasing family of independent compound personal attributes, independent compound legal entity attributes or independent compound brands by enlargement and stretching of parent brands, popularity, trust, prestige, reputation and other personal or legal entity attributes of sellers, persons or legal entities to megabuck audience of independent compound personal attribute owners, independent compound legal entity attribute owners or independent compound brand owners. At the same time, to keep independence of classical parent brands and other personal or legal entity attributes of sellers, what lets to each seller to continue using own classical parent brands at its option, what expands spectrum of independent compound personal attributes, independent compound legal entity attributes or independent compound brands usage in the different areas. Thereat, in traditionally approach such enlargement and stretching of classic brands costs huge amount of money and forces, as traditional types of advertisements are very expensive for companies. In the present invention, for such enlargement and stretching of classic parent brands of sellers and mass advertisement pay independent compound personal attribute owners, independent compound legal entity attribute owners or independent compound brand owners themselves. Thereat to sellers, persons or legal entities it does not cost anything, and their business is expanding.

In the present invention, independent compound brand owners are leaders and profitable life brands themselves and play a role of privileged partners of sellers, persons or legal entities.

The present invention, independent compound personal attribute owners, independent compound legal entity attribute owners or independent compound brands provide an understandable and compact information about tangible and intangible attributes of sellers, and also provides getting mutual life response on the any changes on the market and let to justify expectation of each other.

The present invention provides ability for globalization and internationalisation of independent compound personal attributes, independent compound legal entity attributes or independent compound brands in the framework of general strategy of each seller and provides their market segments enlargement which become more and more similar.

### BRIEF DESCRIPTION OF THE DRAWINGS

FIG. 1 is a comprehensive block diagram showing personal attributes, legal entity attributes or parent brands and other attributes from sellers, persons or legal entities to purchasers ownership selling rights algorithms and following creation of their independent compound personal attributes, independent compound legal entity attributes or independent compound brand;

FIG. 2A is scheme showing independent compound personal attributes, independent compound legal entity attributes or independent compound brands between person and other persons creation algorithm;

FIG. 2B is scheme showing independent compound personal attributes, independent compound legal entity attributes or independent compound brands between famous person and other persons creation algorithm, in terms of very famous person—soccer Zinedine Zidane;

FIG. 3A is scheme showing independent compound personal attributes, independent compound legal entity attributes or independent compound brand between legal entity and persons creation algorithm, in terms of company and his customers;

FIG. 3B is scheme showing independent compound personal attributes, independent compound legal entity attributes or independent compound brand between legal entity and persons creation algorithm, in terms of famous direct selling company Amway and its independent business owners;

FIG. 4 A,B,C are schemes showing an examples of independent compound personal attributes, independent compound legal entity attributes or independent compound brands possible appearance, shapes and colour.

FIG. 5 is scheme showing complicated independent compound personal attributes, independent compound legal entity attributes or independent compound brand between several persons (rights sellers) or legal entities (rights sellers) and other persons (purchasers) or legal entities (purchasers) creation algorithm and also showing cash flow for rights purchasing and annual support cash flow;

FIG. 6 is scheme showing an example of complicated independent compound personal attributes, independent compound legal entity attributes or independent compound brand creation algorithm, a famous rock group Deep Purple (rights seller) and its famous members (rights sellers) and for example, fun Jim Burrow (purchaser) and also showing cash flow for rights purchasing and annual support cash flow;

FIG. 7 is scheme showing an example of complicated family independent compound personal attributes, independent compound legal entity attributes or independent compound brand between any member of family creation algorithm, for example between father (rights seller), mother (rights seller) and daughters (purchasers), sons (purchasers), granddaughters (purchasers), grandsons (purchasers) and other relatives (purchasers) and also showing cash flow for rights purchasing and annual support cash flow;

FIG. 8A is scheme showing independent compound personal attributes, independent compound legal entity attributes or independent compound brands between person (rights seller) and other persons (purchasers) creation algorithm and also showing cash flow for rights purchasing and annual support cash flow;

FIG. 8B is scheme showing independent compound personal attributes, independent compound legal entity attributes or independent compound brand between legal entity (rights seller) and persons (purchasers) creation algorithm and also showing cash flow for rights purchasing and annual support cash flow;

FIG. 8C is scheme showing independent compound personal attributes, independent compound legal entity attributes or independent compound brand between person (rights seller) and legal entities (purchasers) creation algorithm and also showing cash flow for rights purchasing and annual support cash flow;

FIG. 8D is scheme showing independent compound personal attributes, independent compound legal entity attributes or independent compound brand between legal entity (rights seller) and other legal entities (purchasers) creation algorithm and also showing cash flow for rights purchasing and annual support cash flow;

FIG. 9 is scheme showing complicated independent compound personal attributes, independent compound legal entity attributes or independent compound brands between any persons or legal entities and other persons or legal entities creation algorithm, when independent compound personal attribute owners, independent compound legal entity attribute owners or independent compound brand owners become other persons or legal entities but not purchasers, and also cash flow for rights purchasing and annual support cash flow;

FIG. 9 is a schematic diagram showing multi level brand creation and marketing business process an example of direct selling company and its independent business owners;

FIG. 10 is a schematic diagram showing impact on potential customer process and decision to purchase the rights making and independent compound personal attributes, independent compound legal entity attributes or independent compound brand creation in the future;

FIG. 11 is a schematic diagram for explaining the price policy of independent compound personal attributes, independent compound legal entity attributes or independent compound brands using a present business method;

FIG. 12 is a schematic diagram showing opportunities of wide usage of presented business method in the different spheres of society.

FIG. 13A is a schematic diagram showing an advantages and opportunities of presented business method usage for famous persons, as the result their popularity and reputation in the society is growing up and the period of time of their popularity is raising, and also opportunity of own independent compound personal attributes or independent compound brand networks creation.

FIG. 13B is a schematic diagram showing an advantages and opportunities of presented business method of legal entities, as the result their popularity and reputation in own fields and spheres is growing up and the period of time of their popularity is raising, and also opportunity of own independent compound legal entity attributes or independent compound brand networks creation.

### DESCRIPTION OF PREFERRED EMBODIMENT

Next, with reference to the accompanying drawings, a brand creation and marketing business method according to an embodiment of the present invention will be described.

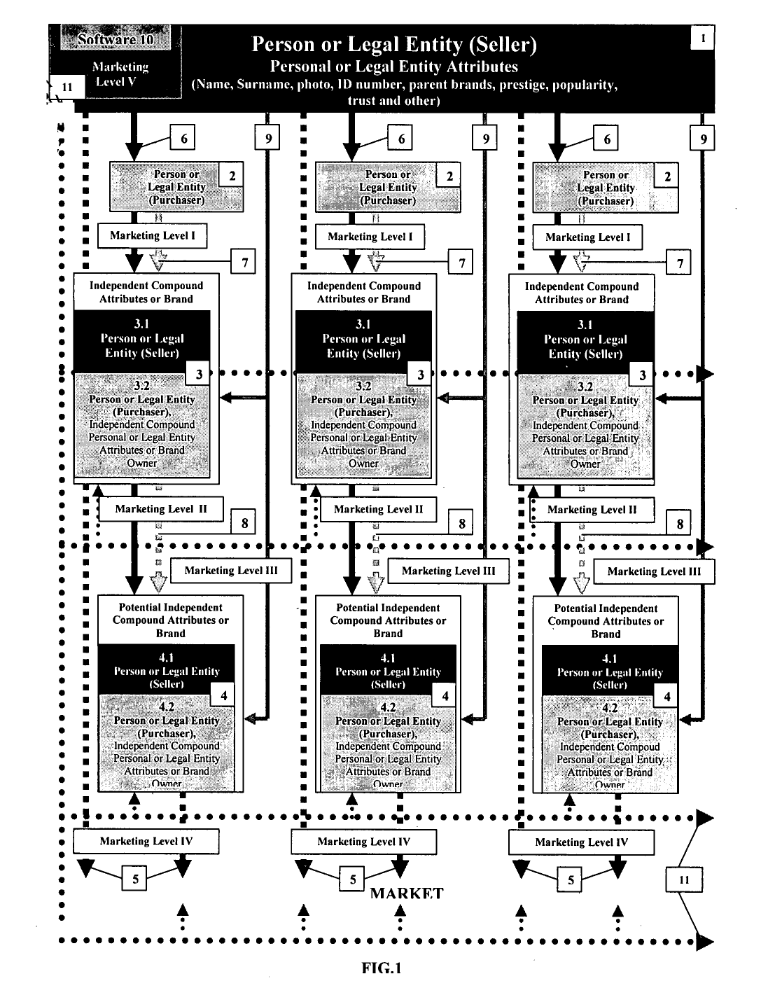

FIG. 1 is a block diagram showing the structure of business processes using algorithms of brand creation and marketing business method according to an embodiment of the present invention;

FIG. 1, In the top of block-diagram marketing level I is showing, which explains multiple selling of definite rights 6 (blue arrows) to use all own parent brands and other personal or legal entity attributes from sellers 1, persons or legal entities to purchaser 2, persons or legal entities algorithm, and also creation of compound product and instrument in terms of independent compound personal attributes, independent compound legal entity attributes or independent compound brands 3, which consist of permanent 3.1 and variable 3.2 parts. Permanent 3.1 part labelled blue colour and characterize sellers, persons or legal entities and contains parent brands and other personal or legal entity attributes, and variable part 3.2 labelled yellow colour and characterize purchasers, persons or legal entities, who hand over own parent brands and other personal or legal entity attributes 7 (yellow arrows) for creation of independent compound personal attributes, independent compound legal entity attributes or independent compound brands. Permanent 3.1 and variable 3.2 parts are joined by single visual decision in recognizable symbol 3, for example square shape.

On FIG. 1, in the middle of block-diagram marketing level II is showing, which explains multiple selling of recommendations 8 (broken yellow lines) from independent compound personal attribute owners, independent compound legal entity attribute owners or independent compound brand owners 3 to other potential purchasers algorithm and following multiple selling of definite rights 6 (blue arrows) from sellers 1, persons or legal entities, to these potential purchasers 4.2, persons or legal entities, to use own personal attributes or legal entity attributes 4.1 and creation of joint product and instrument in terms of independent compound personal attributes, independent compound legal entity attributes or independent compound brands 4, which consist of permanent 4.1 and variable 4.2 parts, and purchasers, persons or legal entities become independent compound personal attribute owners, independent compound legal entity attribute owners or independent compound brand owners.

On FIG. 1, in the middle of block-diagram marketing level III is showing which explains multiple selling of long-time annual support services to independent compound personal attribute owners, independent compound legal entity attribute owners or independent compound brand owners 3 and 4 from sellers 1, persons or legal entities for fixed annual fee and all required connections 9 (green arrows).

On FIG. 1, in the middle of block-diagram marketing level IV is showing, which explains product 5 (red arrows) volume selling from sellers 1, which are provided with new opportunities independent compound personal attribute owners, independent compound legal entity attribute owners or independent compound brand owners 3 and 4, their strong motivation and strengthening ability to sell, increasing algorithm.

On FIG. 1, block-diagram is showing marketing level V with on purpose developed software 10 and all required connections 11 (purple arrows), which provide the implementation of required marketing levels in necessary volume and sequence, independent compound personal attributes, independent compound legal entity attributes or independent compound brands creation, coordination and management, their registration, imaging, training, and also development of this product and instrument effective usage strategies for enlargement of existing market segments and penetration to other target markets.

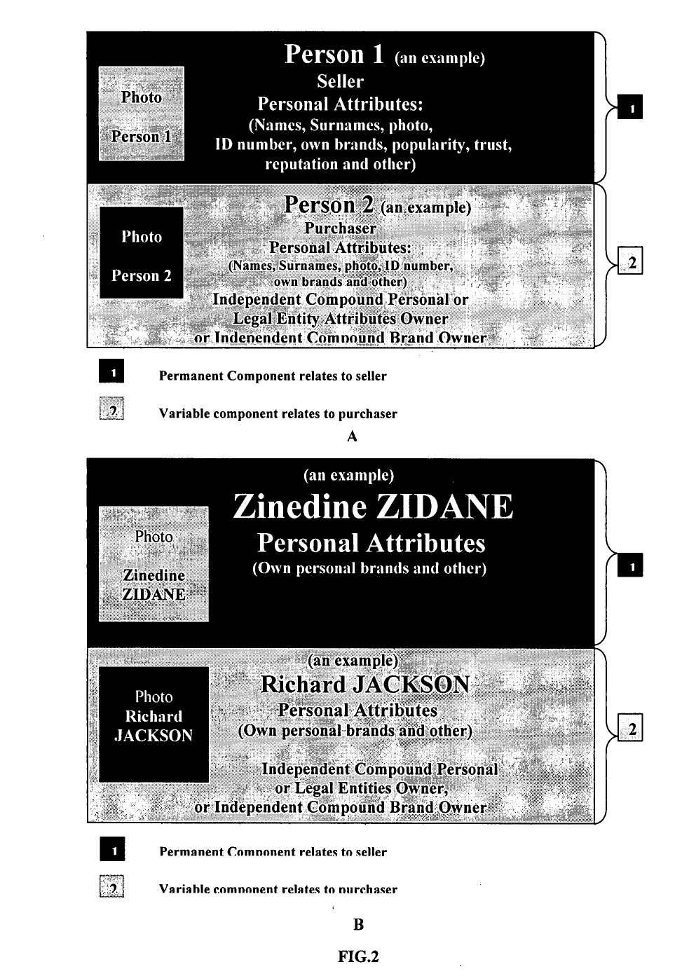

On FIG. 2A is shown, an example of independent compound personal attributes or independent compound brand which is created by two persons. Person 1 is a famous person and he is a seller of own personal attributes or personal brands, popularity, prestige, trust, reputation and other personal attributes. Person 2 is a purchaser of personal attributes from person 1 and he is independent compound personal attribute owner or independent compound brand owner. Person 1 and his parent brands and personal attributes are permanent component. Variable component 2 is increasing from person 2 to person N, forming independent compound personal attribute owners or independent compound brand owners network of person 1.

On FIG. 2B is shown, an example of independent compound personal attributes or independent compound brands in terms of famous person—famous soccer Zinedine Zidane 1, who is a seller of own personal brands, popularity, prestige, trust, reputation and other personal attributes. Person 2 is a fun, for example Richard Jackson. He is a purchaser of personal brands and other personal attributes from Zinedine Zidane and Richard Jackson is independent compound personal attribute owner or independent compound brand owner. Thus, presented business method lets Zinedine Zidane to form own independent compound personal attribute owners or independent compound brand owners network.

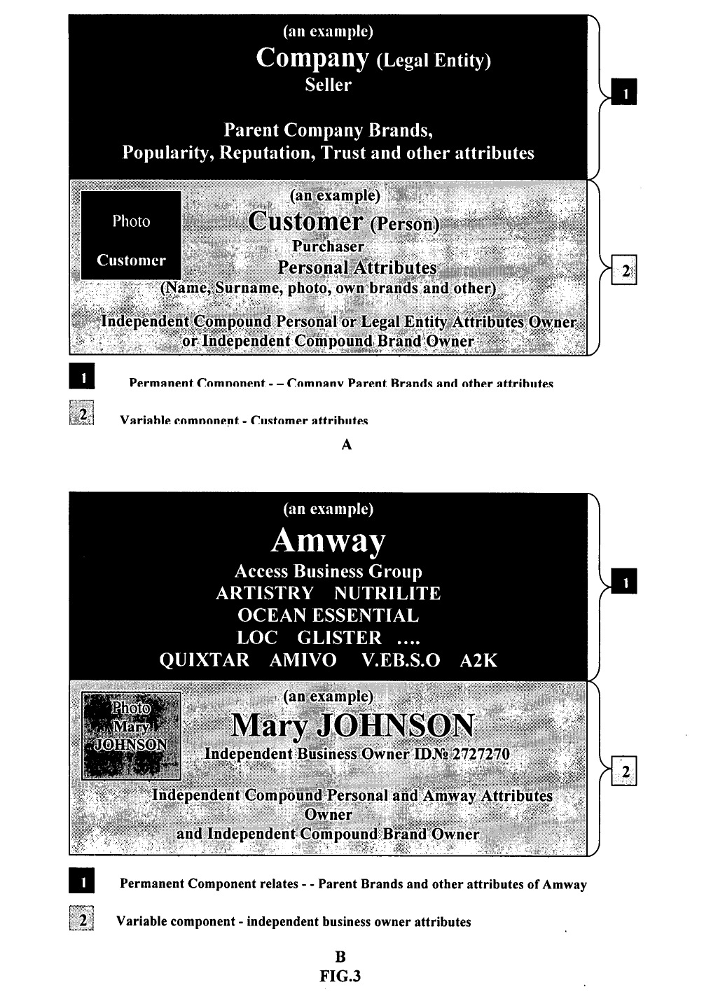

On FIG. 3A is shown, an example of independent compound personal attributes, independent compound legal entity attributes or independent compound brand which is created by any company and its customers. Company 1 is a seller of parent brands and other legal entity attributes. Customer 2 is a purchaser of parent brands and other attributes from company 1 and he is independent compound personal attribute owner, independent compound legal entity attribute owner or independent compound brand owner. Thus, company further develops own network of customers, who become independent compound personal attribute owners, independent compound legal entity attribute owners or independent compound brand owners.

On FIG. 3B is shown, an example of independent compound personal attributes, independent compound legal entity attributes or independent compound brand in terms of direct selling company Amway and its independent business owners. Amway 1 is a seller of parent brands and other own legal entity attributes. Independent business owner 2 is a purchaser of parent brands and other legal entity attributes from Amway 1 and he is independent compound personal attribute owner, independent compound legal entity attribute owner or independent compound brand owner also. Thus, Amway 1 further develops own network of independent business owners, who become independent compound personal attribute owner, independent compound legal entity attribute owner or independent compound brand owners.

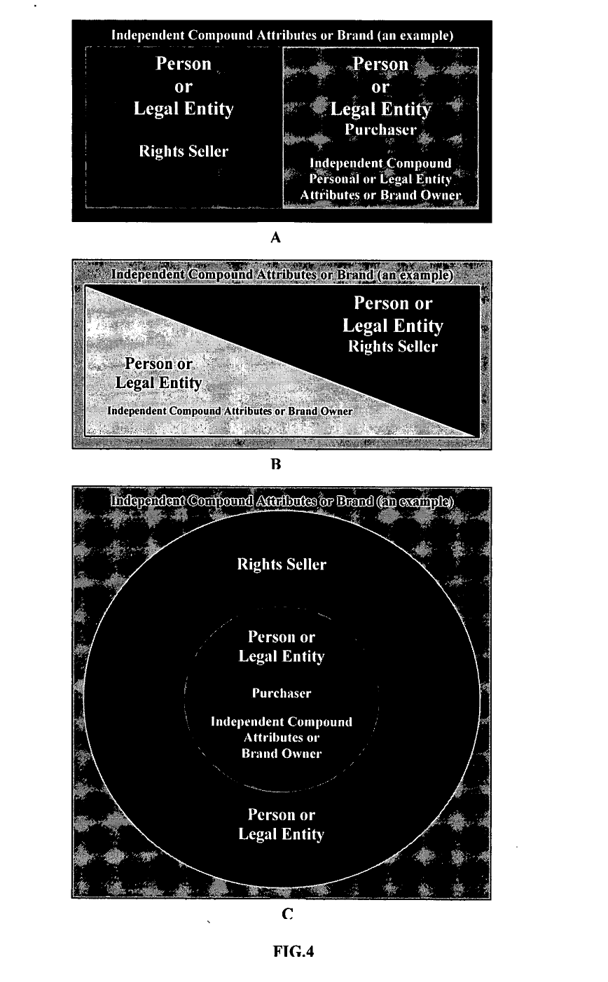

On FIG. 4A.B.C are shown an examples of independent compound personal attribute owners, independent compound legal entity attribute owners or independent compound brands. Shapes and colour variety let to create very various independent compound personal attribute owners, independent compound legal entity attribute owners or independent compound brands.

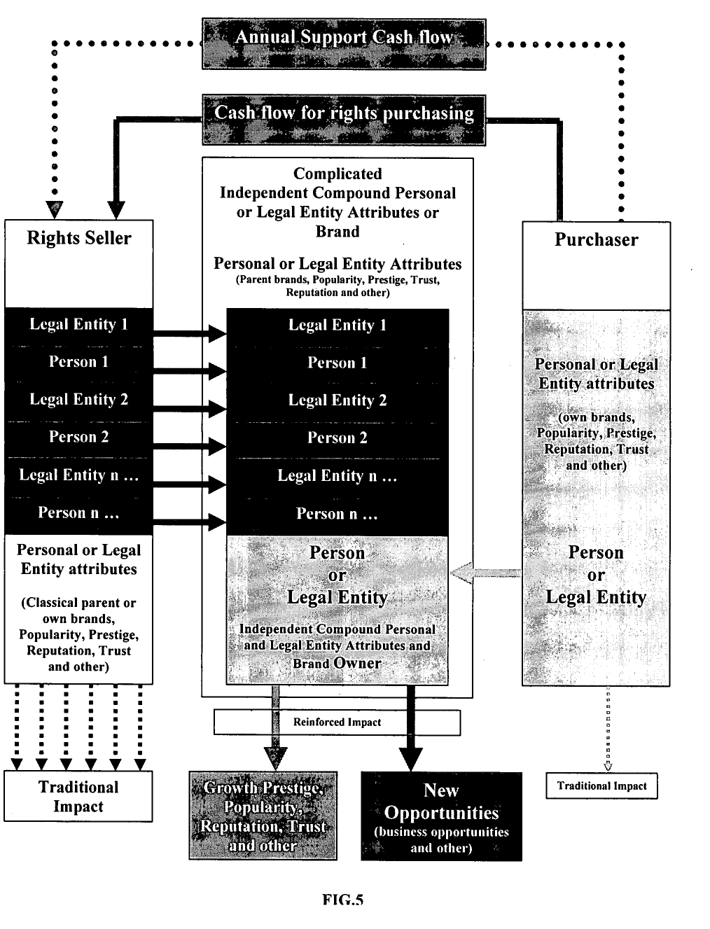

On FIG. 5 is shown an example of complicated independent compound personal attributes, independent compound legal entity attributes or independent compound brand which is created by several persons or legal entities. Persons 1,2 . . . n and legal entities 1,2 . . . n are sellers of parent or legal entity brands, popularity, prestige, trust, reputation and other personal or legal entity attributes. Person or legal entity is purchaser of parent brands and other attributes from sellers and person or legal entity is an independent compound personal attribute owner, independent compound legal entity attribute owner or independent compound brand owner. Thus, purchaser, person or legal entity can become an independent compound personal attributes, independent compound legal entity attributes or independent compound brand owner, who unites several sellers, persons or legal entities simultaneously. Cash flow for rights purchasing directed from purchaser to seller. Annual support cash flow directed from purchaser to seller also. Independent compound personal attributes, independent compound legal entity attributes or independent compound brand opens for independent compound personal attribute owner, independent compound legal entity attribute owner or independent compound brand owner new business opportunities and raises his prestige, social status and gives other psychological advantages.

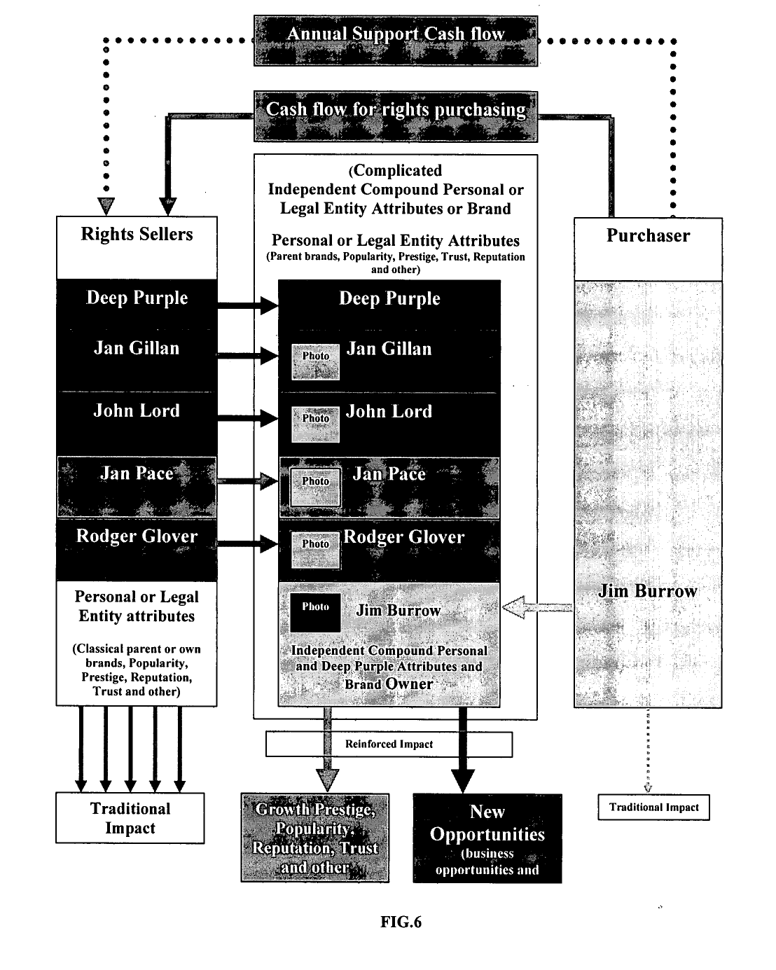

On FIG. 6 is shown an example of complicated independent compound personal attributes, independent compound legal entity attributes or independent compound brand in terms of famous rock group Deep Purple ant its famous rock musicians. Purchaser, for example Jim Burrow, purchases definite rights for parent brands, popularity, prestige, trust, reputation and other legal entity attributes usage from Deep Purple and definite rights for personal brands, popularity, prestige, trust, reputation and other personal attributes usage from each famous rock musicians simultaneously, who are unite in the framework of one independent compound personal attribute, independent compound legal entity attribute or independent compound brand. Thus, Jim Burrow becomes complicated independent compound personal attribute owners, independent compound legal entity attribute owners or independent compound brand owner.

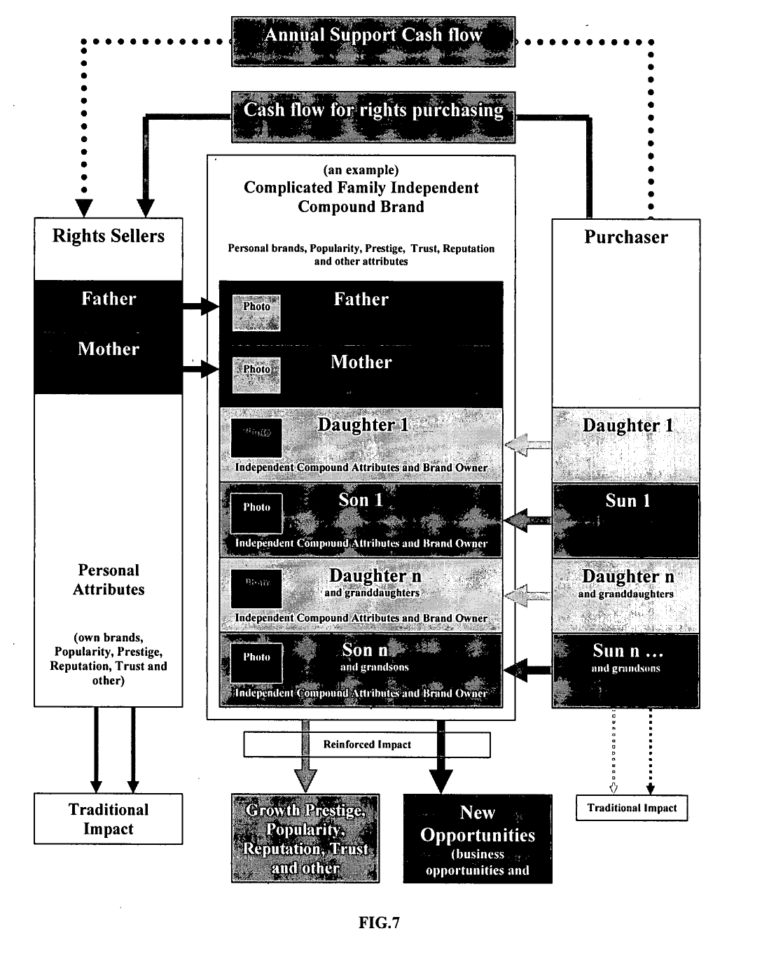

On FIG. 7 is shown, an example of complicated independent compound personal attributes, independent compound legal entity attributes or independent compound brand in terms of any family member, for example between father (seller), mother (seller) and daughters (purchasers), sons (purchasers), granddaughters (purchasers), grandsons (purchasers) and other relatives (purchasers). Purchasers purchasing definite rights to use parent personal attributes or brands from their father and mother and are joining in family independent compound personal attributes, independent compound legal entity attributes or independent compound brand. Thus, daughters (purchasers), sons (purchasers), granddaughters (purchasers), grandsons (purchasers) and other relatives (purchasers) become complicated independent compound personal attribute owners, independent compound legal entity attribute owners or independent compound brand owners.

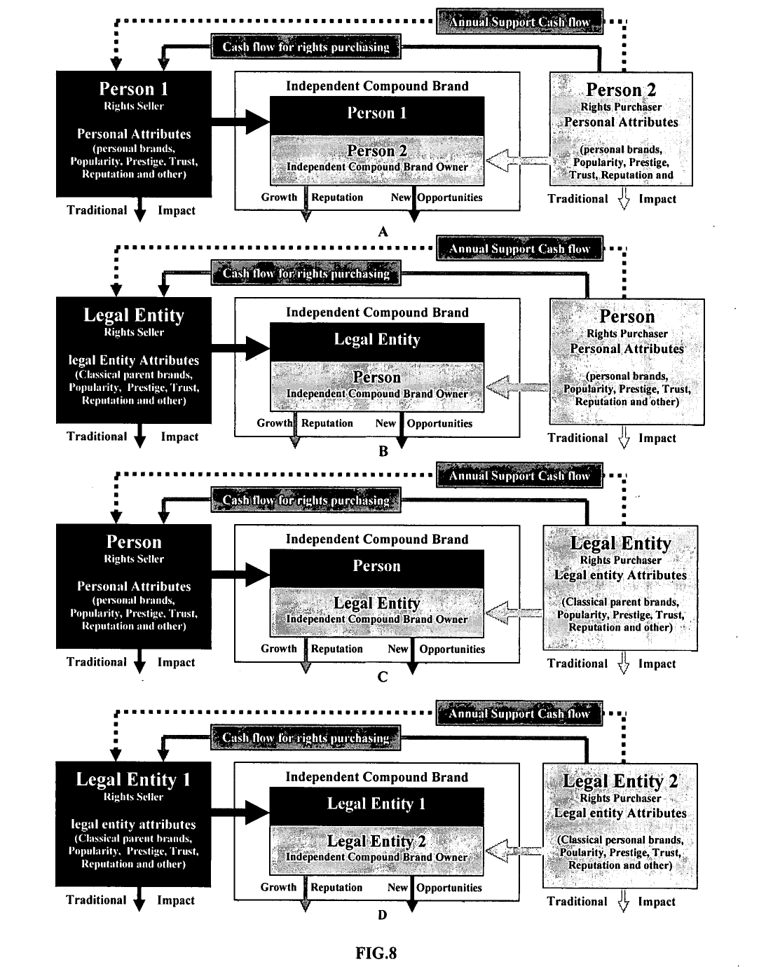

On FIG. 8A,B,C,D different independent compound brands sellers and purchasers combinations are shown. Such combinations are available between: persons (sellers) and persons (purchasers), 8A; legal entities (sellers) and persons (purchasers), 8B; persons (sellers) and legal entities (purchasers), 8C; legal entities (sellers) and legal entities (purchasers), 8D.

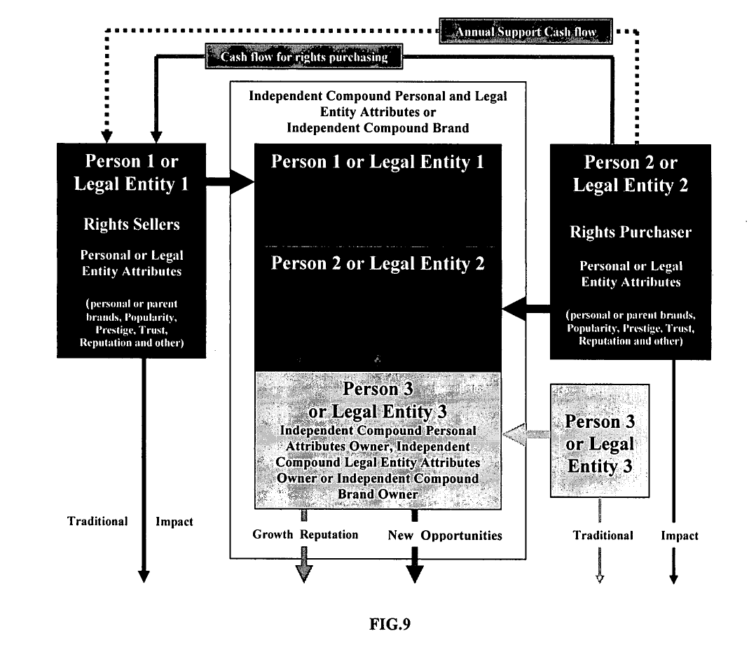

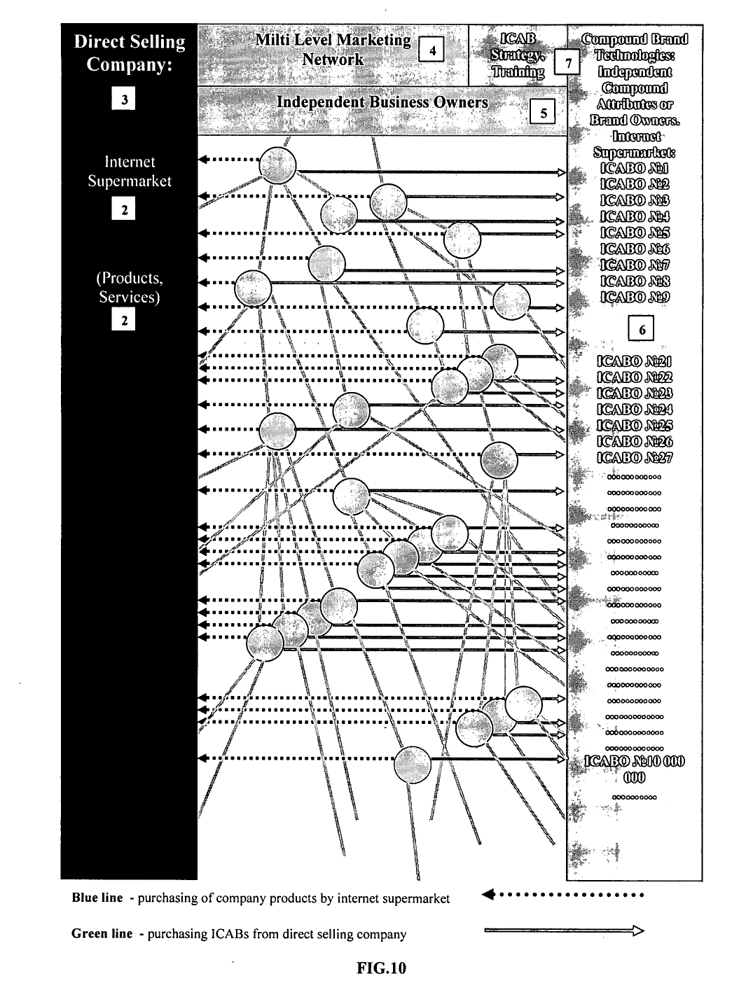

On FIG. 9 is shown, how complicated independent compound personal attributes, independent compound legal entity attributes or independent compound brand can look like which is creating by several persons or legal entities. Persons 1 or legal entity 1 are sellers of personal or legal entity attributes for example, brands, popularity, prestige, trust, reputations. person 2 or legal entity 2 are purchasers of personal or legal entity attributes from sellers. Thus, independent compound personal attribute owners, independent compound legal entity attribute owners or independent compound brand owners are other person 3 or legal entity 3, who are neither purchasers nor sellers. Cash flow for rights purchasing is directed from purchaser to seller. Annual support cash flow directed from purchaser to seller also.

On FIG. 9 block-diagram is shown which explains multi level brand creation and marketing business method. On the left of this block-diagram, coloured in blue, shows traditional multilevel internet commerce marketing scheme via internet supermarket 1 products 2 direct selling company 3 via independent business owners 5, marked with circles and yellow lines, which are included in multilevel marketing network 4 of direct selling company 3. The products of direct selling company 3 purchase and selling processes are shown with blue broken arrows. The first part of block-diagram coloured in yellow and denoted with yellow arrows, shows analogical multilevel internet commerce of independent compound personal attributes, independent compound legal entity attributes or independent compound brands 6 from direct selling company 3 to independent business owners 5, for example via on purpose created company (for example under the name Compound Brand Technologies) 7, which will provide creation and realization of independent compound personal attributes, independent compound legal entity attributes or independent compound brands 6, brand strategy development, training, management, activities coordination of independent compound brand owners.

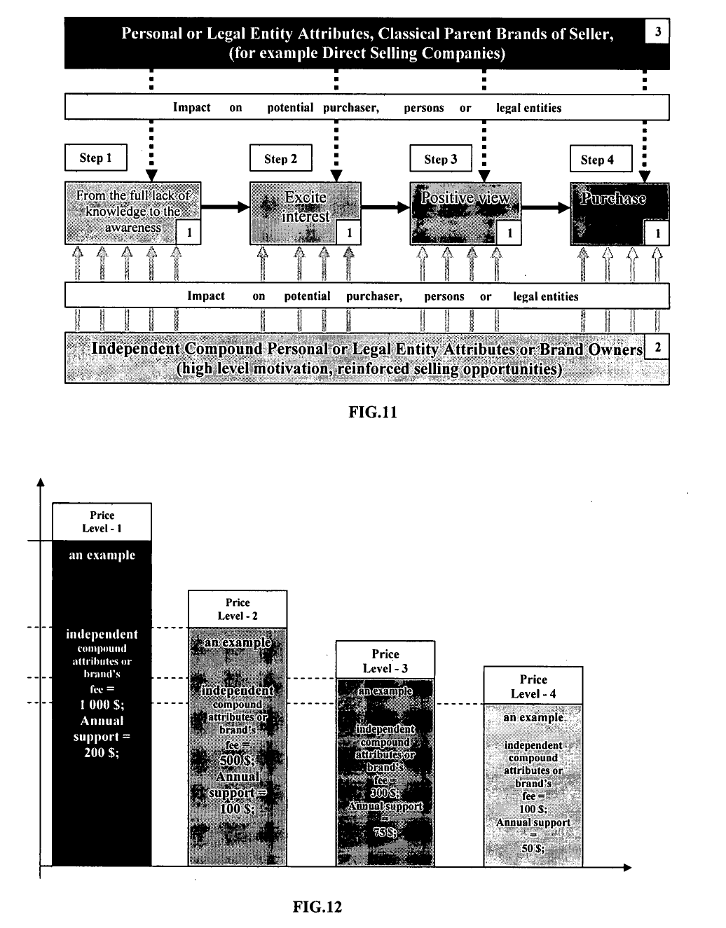

On FIG. 11 block-diagram is shown which explains decision making to purchase the rights processes and creation of independent compound personal attributes, independent compound legal entity attributes or individual compound brand by each potential purchaser 1, which consist of as minimum from 4 basic decision making stages, namely: step 1 is from full lack of knowledge to the awareness, step 2 is excite of interest, step 3 is positive view, step 4 is purchase. As a result, the decision to purchase the rights is coming under the pressure from two sides simultaneously, that are: under the active pressure of mass advertisements from the side of strong motivated independent compound personal attribute owners, independent compound legal entity attribute owners or independent compound brand owners 2 and under the traditional impact from the side of parent brands of seller 1.

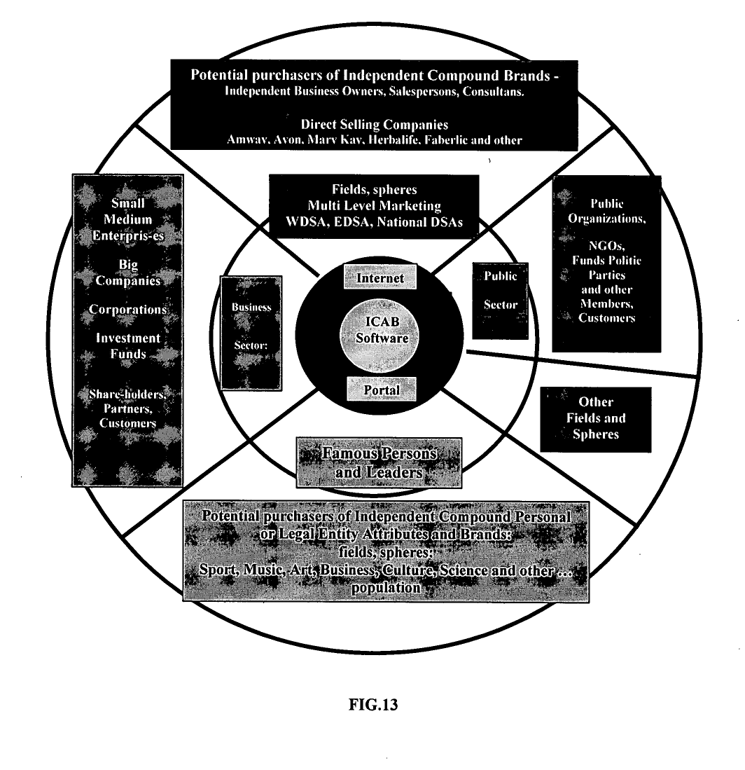

On FIG. 12 block-diagram is shown which explains the price policy of independent compound personal attributes, independent compound legal entity attributes or individual compound brands (prices are given as an example). Real price levels will be defined by correct chosen brand strategy and price policy of each seller, person or legal entity. The correct choice of price policy lets to define of necessary limits for each independent compound personal attribute owner, independent compound legal entity attribute owner or independent compound brand owner and his responsibility to seller, person or legal entity. The correct choice of price policy lets to minimize and diversify risks, connected to parent brands and other attributes of seller damage, and risks are diversifying and reducing inversely to permanent increasing quantity of independent compound personal attribute owners, independent compound legal entity attribute owners or independent compound brand owners, distributing between their megabuck audience. Price level 1 is a quite high price, for example 1000 $, for purchasers for rights purchasing and ability to create independent compound personal attributes, independent compound legal entity attributes or independent compound brands with famous persons or legal entities, and also quite high annual support fee, for example 200 $. Such high price of independent compound personal attributes, independent compound legal entity attributes or independent compound brand means considerably wide frames of rights possession in high level of responsibility of each independent compound personal attribute owner, independent compound legal entity attribute owner or independent compound brand owner to sellers, what results personal attributes, legal entity attributes or parent brands damage risks reduction. Conversely, price level 4 is a quite low price, for example 100 $, for purchasers for rights purchasing and ability to create independent compound personal attributes, independent compound legal entity attributes or independent compound brands with famous persons or legal entities, and also quite high annual support fee, for example 50 $. Such low price of independent compound personal attributes, independent compound legal entity attributes or independent compound brand means quite tight frames of rights possession and low level of responsibility of each independent compound personal attribute owner, independent compound legal entity attribute owner or independent compound brand owner to sellers, what is not results sellers' personal attributes, legal entity attributes or parent brands damage risks reduction. Hereby, price policy (levels 1-4 or more) settles definite balance between: independent compound personal attributes, independent compound legal entity attributes or independent compound brands rights possession level, independent compound personal attribute owners, independent compound legal entity attribute owners or independent compound brand owners responsibility level to sellers family brands and other personal or legal entity attributes of sellers any damage risks level.

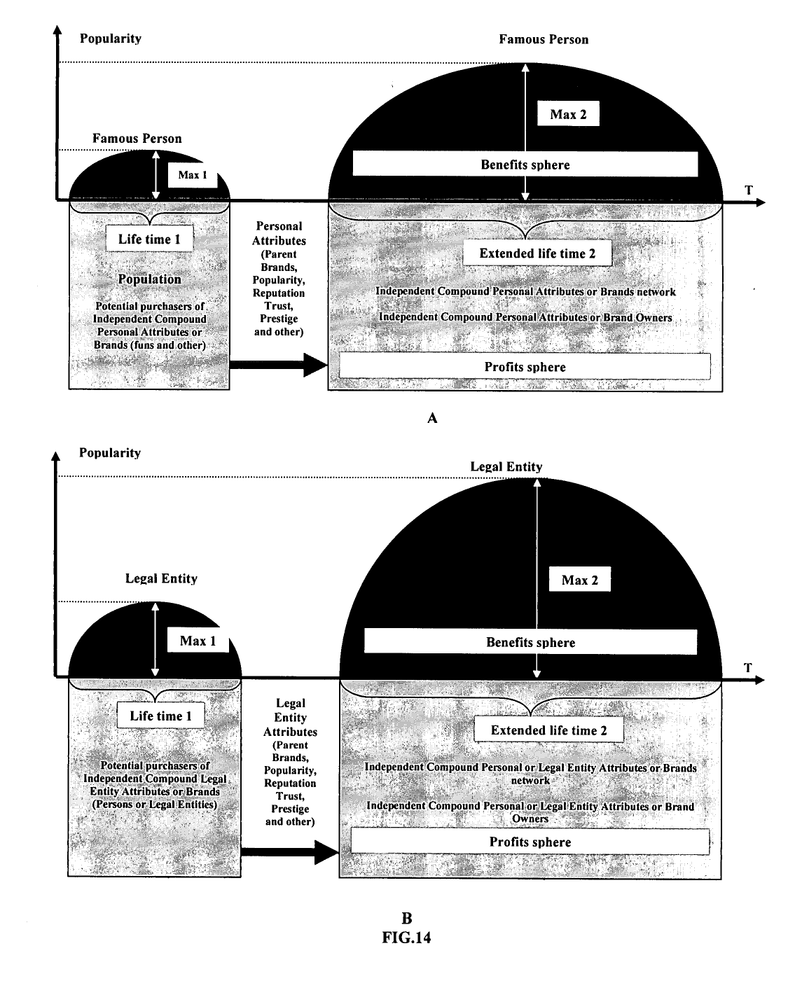

On FIG. 13 an example of block-diagram is shown, which explains a huge opportunities of presented business method and can be used in very different areas and persons and legal entities activities spheres and in very wide population strata. In the block-diagram middle part, marked in yellow and blue colours symbolizes internet portal and on purpose developed of independent compound personal attributes, independent compound legal entity attributes or independent compound brand software, as instrument for effective usage of presented business method. In the bottom of the block-diagram, marked aquamarine colour, shows opportunities of presented business method for famous and popular persons, and other leaders in the different areas and activities spheres, for example, grade and famous sportsmen in the different sports, grand and famous musicians, singers, artists, actors, businessmen, scientists, and other grand and famous people and other VIP. The top part of diagram, marked red color shows opportunities of presented business method in the multilevel marketing area. In this part of the block-diagram you can see, that all direct selling companies are united World Direct Selling Association, European Direct Selling Association and National Direct Selling Associations. In terms of more major from them, such as Amway, Mary Kay, Avon, Herbalife, Faberlic and their independent business owners' networks potential market for usage presented business method is shown. Left part of block-diagram, marked green colour shows opportunities of presented business method in other areas of business sector, namely in the area of Small and Medium Enterprises (SMEs), worldwide Big Companies, Corporations and Investment Funds and other. In terms of such company as IBM several hundred thousands of stockholders and partners, who are potential independent compound personal attribute owners, independent compound legal entity attribute owners or independent compound brand owners. The left part of block-diagram, marked lilac colour shows opportunities of presented business method in the area of Public Sector, including different public and non-governmental organizations, public funds, politic parties and other organizations, which has many members. In the right part of the block-diagram, marked brown colour opportunities of presented business method are shown also, which has in other areas and activities spheres.

On FIG. 14A how popularity and reputation of famous person is growing up as a result of implementation of presented business method and creation of own independent compound personal attributes, independent compound legal entity attributes or independent compound brands network. It can be seen from FIG. 14A that popularity and reputation of famous person has definite level with own maximum 1 and period of popularity is life time 1. Using opportunities of presented business method and creation of own independent compound personal attributes, independent compound legal entity attributes or independent compound brands network it is seen, like essential level of famous person popularity maximum 2 and period of popularity life time 2 can grow up. Thus, presented business method lets to famous persons expand own popularity and keep it for a more long time.

On FIG. 14B is shown, popularity and reputation of legal entity is increasing as a result of implementing of presented business method creation of own independent compound personal attributes, independent compound legal entity attributes or independent compound brands network. You can see on FIG. 14B that popularity of legal entity has definite level with own maximum 1 and period of popularity is life time 1. Implementing abilities of presented business method and creation of own independent compound personal attributes, independent compound legal entity attributes or independent compound brands network it can be seen how essential level of legal entity popularity can be increased maximum 2 and period of popularity life time 2. Thus, presented business method lets to legal entities enlarge own popularity and keep it for a more long time.

What is claimed is:

1. A brand creation and marketing business method, comprising several following marketing levels of: marketing level I is performed by following algorithms: by means of multiple sales of definite rights from sellers, persons or legal entities, to use their personal attributes or legal entity attributes, for example names, surnames, pictures, own corporate parent brands, logotypes, popularity, reputation, trust, prestige to as many as possible purchasers, persons or legal entities and creation in the future of conjoint product and instrument in terms of independent compound personal attributes, independent compound legal entity attributes or independent compound brands, which contain permanent and variable parts and are united with single visual or sound solution in recognisable symbol of definite shape, colour or sound, and purchasers, persons or legal entities, or sellers and purchasers together on certain rights become independent compound personal attribute owners, independent compound legal entity attribute owners or independent compound brand owners; marketing level II is performed by following algorithms: by means of multiple sales of recommendations from independent compound personal attribute owners, independent compound legal entity attribute owners or independent compound brand owners to other potential purchasers, persons or legal entities, and following multiple sales of definite rights form sellers, persons or legal entities, to these potential purchasers, persons or legal entities to use their personal attributes or legal entity attributes and creation of conjoint product and instrument in terms of independent compound personal attributes, independent compound legal entity attributes or independent compound brands, and purchasers, persons or legal entities become independent compound personal attribute owners, independent compound legal entity attribute owners or independent compound brand owners; marketing level III is performed by means of multiple sales of long-term annual support services to independent compound personal attribute owners, independent compound legal entity attribute owners or independent compound brand owners from sellers, persons or legal entities for fixed annual fee; marketing level IV is provided by new opportunities to independent compound personal attribute owners, independent compound legal entity attribute owners or independent compound brand owners, their intense motivation and strengthening their ability to sale, which affect increasing of services and products sales from sellers, persons or legal entities; marketing level V is performed by means of special developed software, which provides achievement of necessary marketing levels in necessary capacity and sequence, creation, coordination and management of independent compound personal attributes, independent compound legal entity attributes or independent compound brands, their registration, displaying, training, development of new brand strategies of effective usage of this product and instrument for expansion of existing market segments and penetrate to other target markets.

2. The brand creation and marketing business method according to claim 1, wherein permanent part of independent compound personal attributes, independent compound legal entity attributes or independent compound brands contain names, surnames, identification numbers, images, pictures, individual corporate parent brands, trade marks, logotypes, popularity, reputation, trust, prestige and other personal attributes or legal entity attributes of sellers, whereas variable part of independent compound personal attributes, independent compound legal entity attributes or independent compound brands contain names, surnames, identifications numbers, images, pictures, individual corporate parent brands, trade marks, logotypes and other personal attributes or legal entity attributes of purchasers. Permanent and variable parts of independent compound personal attributes, independent compound legal entity attributes or independent compound brands are joint together which are united with single visual or sound solution in recognizable symbol of definite shape, colour or sound, for example square, sphere or any other shape with definite colour or colour background or sound background, and personal attributes, legal entity attributes or parent brands and personal attributes or legal entity attributes of sellers are in definite part of this symbol, for example, in the top or in other part of this symbol, for example in the bottom, personal attributes, legal entity attributes or parent brands and personal attributes or legal entity attributes of purchasers are found, who becomes independent compound personal attribute owners, independent compound legal entity attribute owners or independent compound brand owners.

3. The brand creation and marketing business method according to claim 1, wherein creation of independent compound personal attributes, independent compound legal entity attributes or independent compound brands is performed by following algorithm, when sellers of definite rights to use names, surnames, pictures, own corporate parent brands, logotypes, popularity, reputation, trust, prestige and other personal or legal entity attributes are several persons or legal entities, and purchasers are other persons or legal entities, when independent compound personal attribute owners, independent compound legal entity attribute owners or independent compound brand owners can become as purchasers as other persons or legal entities, and ownership of all personal or legal entity attributes of sellers which are unchanged belongs to sellers.

4. The brand creation and marketing business method according to claim 1, wherein creation of independent compound personal attributes, independent compound legal entity attributes or independent compound brands is performed by following algorithm, when sellers of definite rights to use names, surnames, pictures, own corporate parent brands, logotypes, popularity, reputation, trust, prestige and other personal or legal entity attributes are persons or legal entities, and purchasers are other persons or legal entities, when independent compound personal attribute owners, independent compound legal entity attribute owners or independent compound brand owners become sellers and purchasers together on definite rights, and all personal or legal entity attributes of sellers and purchasers are unchanged and in their ownership.

5. The brand creation and marketing business method according to claim 1, wherein creation of independent compound personal attributes, independent compound legal entity attributes or independent compound brands is performed by following algorithm, when sellers of definite rights to use names, surnames, pictures, own corporate parent brands, logotypes, popularity, reputation, trust, prestige and other personal or legal entity attributes are persons, and purchasers are other persons, and independent compound brand owners become independent compound personal attribute owners, independent compound legal entity attribute owners or purchasers and personal attributes of sellers are unchanged and in sellers' ownership.

6. The brand creation and marketing business method according to claim 1, wherein creation of independent compound personal attributes, independent compound legal entity attributes or independent compound brands is performed by following algorithm, when sellers of definite rights to use names, surnames, pictures, own corporate parent brands, logotypes, popularity, reputation, trust, prestige and other personal or legal entity attributes are legal entities and purchasers are persons, when independent compound personal attribute owners, independent compound legal entity attribute owners or independent compound brand owners become purchasers and all legal entity attributes of sellers are unchanged and in sellers' ownership.

7. The brand creation and marketing business method according to claim 1, wherein creation of independent compound personal attributes, independent compound legal entity attributes or independent compound brands is performed by following algorithm, when sellers of definite rights to use names, surnames, pictures, own corporate parent brands, logotypes, popularity, reputation, trust, prestige and other personal or legal entity attributes are persons, and purchasers are legal entities, when independent compound personal attribute owners, independent compound legal entity attribute owners or independent compound brand owners became purchasers and all personal attributes of sellers are unchanged and in sellers' ownership.

8. The brand creation and marketing business method according to claim 1, wherein creation of independent compound personal attributes, independent compound legal entity attributes or independent compound brands is performed by following algorithm, when sellers of definite rights to use names, surnames, pictures, own corporate parent brands, logotypes, popularity, reputation, trust, prestige and other personal or legal entity attributes are legal entities and purchasers are other legal entities, when independent compound personal attribute owners, independent compound legal entity attribute owners or independent compound brand owners become purchasers and all legal entity attributes of sellers are unchanged and in sellers' ownership.

9. The brand creation and marketing business method according to claim 1, wherein independent compound personal attributes, independent compound legal entity attributes or independent compound brands obtain dual property, that is in one case it is a product, which has market perspective and market price, and in other case it is an effective management, advertisement, promotion, branding, successful strategies implementation and effective economy policy instrument which allows to independent compound personal attribute owners, independent compound legal entity attribute owners or independent compound brand owners to achieve mass selling, keeping their individuality simultaneously and ensure increasing of products and services volumes selling, expansion of existing market segments, and penetration to other target markets.

10. The brand creation and marketing business method according to claim 1, wherein independent compound personal attributes, independent compound legal entity attributes or independent compound brands are provide intermediate barriers of protection for personal legal attributes or parent brands and personal or legal attributes of sellers from its damage and provide distance between personal attributes, legal entity attributes or parent brands and personal or legal attributes of sellers and customers and independent compound personal attribute owners, independent compound legal entity attribute owners or independent compound brand owners take all risks and responsibilities for any damage, however damage risks are controllable and reducing inversely to increasing quantity of independent compound personal attribute owners, independent compound legal entity attribute owners or independent compound brand owners, distributing among their megabuck audience.

11. The brand creation and marketing business method according to claim 1, wherein independent compound personal attribute owners, independent compound legal entity attribute owners or independent compound brand owners implement mass managed advertisement and they are active deliveries of this advertisement and also life brands, which have multiple impact to purchasers and customers on the subconscious and conscious levels and pushes them to the decision to purchase independent compound personal attributes, independent compound legal entity attributes or independent compound brands and/or products and services from sellers.

12. The brand creation and marketing business method according to claim 1, wherein single management system by means of developed software provides effective management of creation, selling and mass output of the permanently raising of independent compound personal attributes, independent compound legal entity attributes or independent compound brands to the market process, and also provides coordination of all activities of all independent compound personal attribute owners, independent compound legal entity attribute owners or independent compound brand owners in the frameworks of all brand strategies.

13. The brand creation and marketing business method according to claim 1, wherein creation of independent compound personal attributes, independent compound legal entity attributes or independent compound brands is performed by following algorithm, when in the created independent compound personal attributes, independent compound legal entity attributes or independent compound brands it is foreseen an opportunity to change independent compound personal attribute owners, independent compound legal entity attribute owners or independent compound brand owners, sellers, purchasers, and also an opportunity to change their quantity.
